(19) United States
(12) Patent Application Publication
(10) Pub. No.: US 2017/0263271 A1
(43) Pub. Date: Sep. 14, 2017

(54) MAGNETIC DISK APPARATUS AND CONTROL METHOD

(71) Applicant: Kabushiki Kaisha Toshiba, Tokyo (JP)

(72) Inventors: Tetsuya Tabuchi, Setagaya Tokyo (JP); Daigo Nakamura, Yokohama Kanagawa (JP); Takao Abe, Yokohama Kanagawa (JP); Mitsuhiro Muto, Yokohama Kanagawa (JP)

(21) Appl. No.: 15/257,380

(22) Filed: Sep. 6, 2016

Related U.S. Application Data
(60) Provisional application No. 62/306,393, filed on Mar. 10, 2016.

(51) Int. Cl. G11B 5/09; G11B 33/14

(52) U.S. Cl. CPC G11B 5/09; G11B 33/144

(57) ABSTRACT

According to one embodiment, there is provided a magnetic disk apparatus including an actuator, a shock detection circuit, a temperature measurement circuit, and a controller circuit. The actuator holds a magnetic head that accesses a magnetic disk. The shock detection circuit includes an acceleration sensor that detects acceleration during driving of the actuator. The temperature measurement circuit measures a temperature during driving of the actuator. The controller circuit changes sensitivity of the shock detection circuit according to a temperature change rate obtained from the measured temperature.

### CROSS-REFERENCE TO RELATED APPLICATIONS

This application is based upon and claims the benefit of priority from U.S. Provisional Application No. 62/306,393, filed on Mar. 10, 2016; the entire contents of which are incorporated herein by reference.

### FIELD

Embodiments described herein relate generally to a magnetic disk apparatus and a control method.

### BACKGROUND

In a magnetic disk apparatus in recent years, there is a trend of increasing density of data stored in a magnetic disk. Along with this, there is a trend of narrowing a track pitch of the magnetic disk. In the case of writing data by a magnetic head in a magnetic disk with a narrow track pitch, it is desirable to suppress writing in an offtrack state.

### BRIEF DESCRIPTION OF THE DRAWINGS

FIG. 1 is a block diagram illustrating a configuration of a magnetic disk apparatus according to an embodiment;

FIG. 2 is a plan view illustrating a location of occurrence of thermal shock in the embodiment;

FIG. 3 is a sectional view illustrating the location of occurrence of the thermal shock in the embodiment;

FIG. 4 is a perspective view illustrating the location of occurrence of the thermal shock in the embodiment;

FIG. 5 is a diagram illustrating write operation in the embodiment;

FIG. 6 is a flowchart illustrating an operation of the magnetic disk apparatus according to the embodiment;

FIG. 7 is a diagram illustrating an operation of temperature gradient calculation in the embodiment; and

FIG. 8 is a flowchart illustrating another operation of the magnetic disk apparatus according to the embodiment.

### DETAILED DESCRIPTION

In general, according to one embodiment, there is provided a magnetic disk apparatus including an actuator, a shock detection circuit, a temperature measurement circuit, and a controller circuit. The actuator holds a magnetic head that accesses a magnetic disk. The shock detection circuit includes an acceleration sensor that detects acceleration during driving of the actuator. The temperature measurement circuit measures a temperature during driving of the actuator. The controller circuit changes sensitivity of the shock detection circuit according to a temperature change rate obtained from the measured temperature.

Exemplary embodiments of a magnetic disk apparatus will be explained below in detail with reference to the accompanying drawings. The present invention is not limited to the following embodiments.

### Embodiments

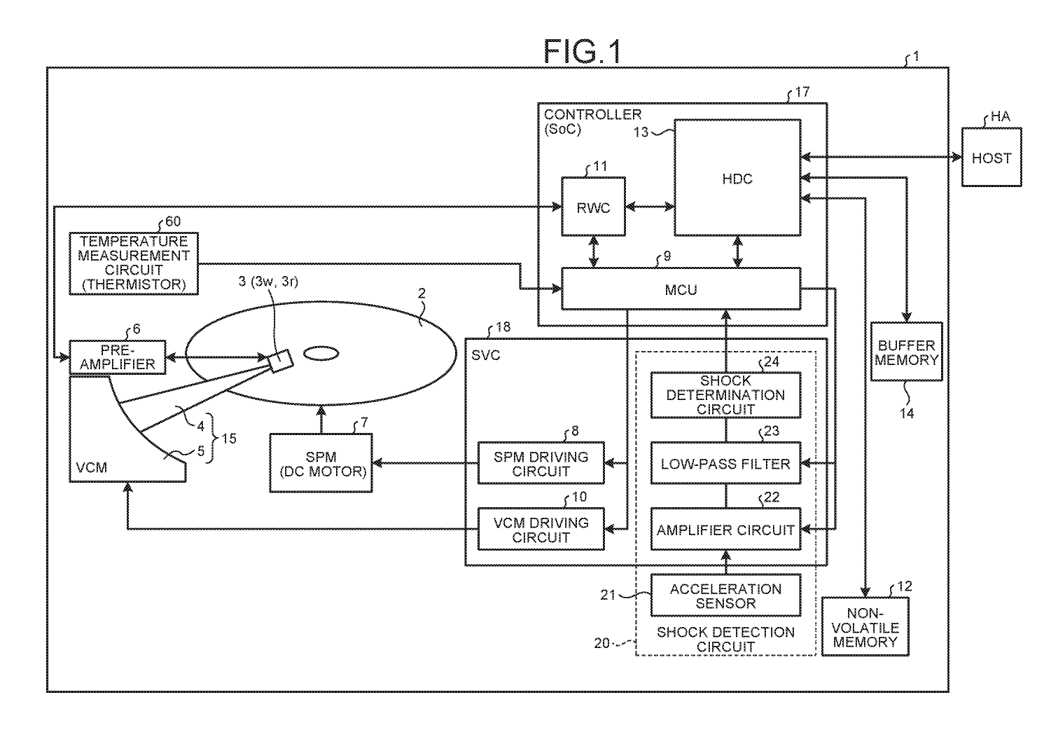

A magnetic disk apparatus 1 according to an embodiment will be described with reference to FIG. 1. FIG. 1 is a block diagram illustrating a configuration of the magnetic disk apparatus 1.

As illustrated in FIG. 1, the magnetic disk apparatus 1 includes a magnetic disk 2, a spindle motor (SPM) 7, an actuator 15, an SPM driving circuit 8, a voice coil motor (VCM) driving circuit 10, a preamplifier 6, a read/write channel (RWC) 11, a microcontroller unit (MCU) 9, a non-volatile memory 12, a hard disk controller (HDC) 13, and a buffer memory 14. Configuration including the RWC 11, the HDC 13, and the MCU 9 may be implemented as a controller circuit 17 and, for example, may be mounted as a system-on-chip (SoC).

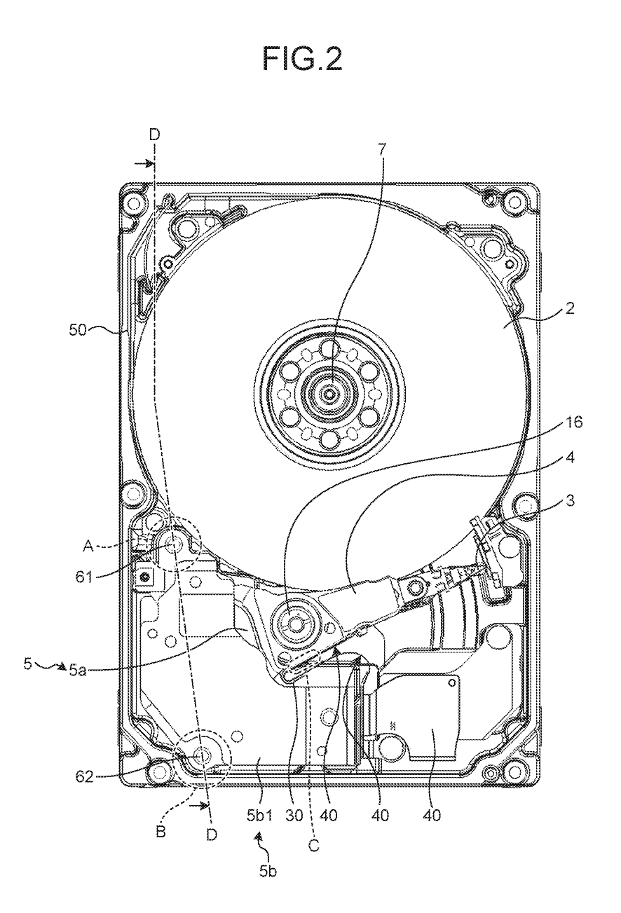

The SPM 7 may be a DC motor, for example, and rotates the magnetic disk 2. The actuator 15 includes a voice coil motor (VCM) 5, a pivot 16 (refer to FIG. 2), and an arm 4. The arm 4 holds a magnetic head 3 at its tip. According to control of the MCU 9, the VCM 5 rotates the arm 4 using the pivot 16 as a shaft, thereby moving the magnetic head 3 in a substantially radial direction of the magnetic disk 2 to be positioned. The magnetic head 3 includes a read head 3r that reads data of the magnetic disk 2 and a write head 3w that writes data onto the magnetic disk 2.

The SPM driving circuit 8 drives the SPM 7 according to control of the MCU 9. The VCM driving circuit 10 drives the VCM 5 according to control of the MCU 9.

The preamplifier 6 amplifies a signal read from the magnetic disk 2 by the read head 3r. The data to be written onto the magnetic disk 2 are converted into a current signal by the preamplifier 6, and then, written onto the magnetic disk 2 by the write head 3w.

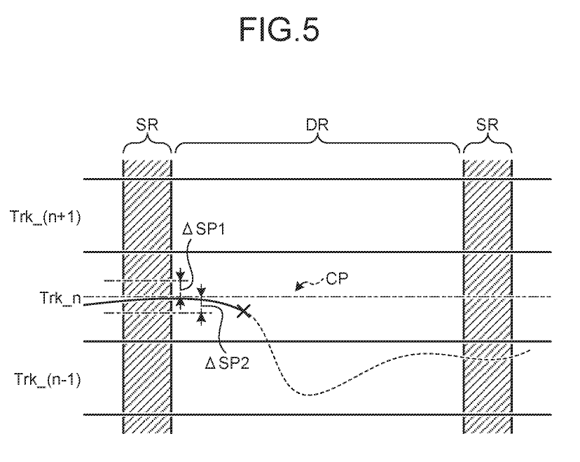

The RWC 11 receives information to be written onto the magnetic disk 2 from the buffer memory 14 via the HDC 13, and encodes the information. The RWC 11 decodes the signal read from the magnetic disk 2 and amplified by the preamplifier 6, and supplies the signal to the HDC 13. Note that the data decoded by the RWC 11 include user data written into a data region DR (refer to FIG. 5) and servo information written into a servo region SR (refer to FIG. 5).

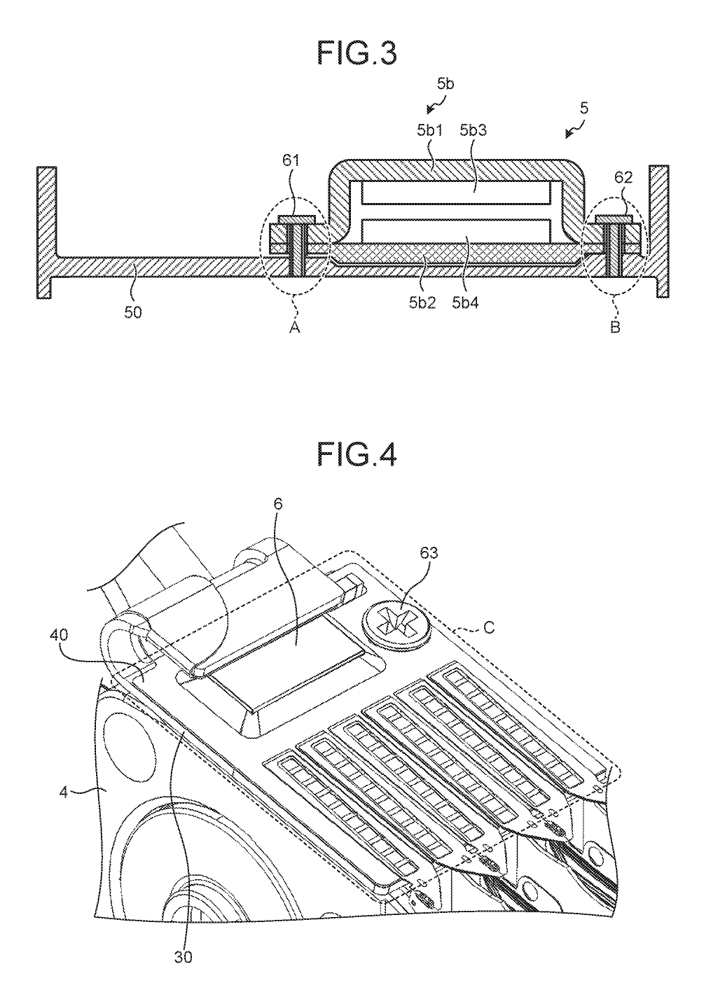

The MCU 9 performs overall control of individual portions of the magnetic disk apparatus 1. For example, the servo information periodically provided onto the magnetic disk 2 is read by the magnetic head 3 and supplied to the MCU 9. According to the servo information, the MCU 9 controls the actuator 15 so as to perform positioning of the magnetic head 3 with respect to the magnetic disk 2. For example, the VCM 5 includes a voice coil 5a and a magnetic circuit 5b (for each, refer to FIG. 2). The magnetic circuit 5b is attached to a housing 50 (refer to FIG. 3). The actuator 15 causes the magnetic head 3 to perform seeking via the arm 4, according to a current supplied to the voice coil 5a.

The non-volatile memory 12 is connected to the MCU 9 and configured to be rewritable by the MCU 9.

The HDC 13 performs interface operation with respect to a host HA and performs data transmission and reception between the magnetic disk apparatus 1 and the host HA. The HDC 13 also extracts servo information from the data decoded by the RWC 11. More specifically, the HDC 13 generates a pulsed servo gate signal and determines that the read data are servo information read from the servo region SR in a case where the pulse is in an active state, and that the read data are user data read from the data region DR in a case where the pulse is in an non-active state.

The buffer memory 14 buffers data transmitted and received between the HDC 13 and the host HA.

In the magnetic disk apparatus 1, temperature inside the housing 50 is likely to increase due to writing and reading of information for the magnetic disk 2, or the like. The increased temperature inside the housing 50 might produce stress due to a difference in a coefficient of thermal expansion on each of members and thermal shock might occur. In another case where an apparatus including the magnetic disk apparatus 1 and the host HA is moved to an environment with different temperatures, e.g., from indoor to outdoor or outdoor to indoor, this might produce stress due to a difference in a coefficient of thermal expansion on each of members within the housing 50 and thermal shock might occur. Thermal shock occurs as follows. When a temperature change rate (temperature gradient) is high, an adjacent substance shifts at a mechanical joint position between members by the difference in the coefficient of thermal expansion. When the strain due to the stress caused by this shift of joint position is released, vibration due to the shock occurs as thermal shock.

Specifically, thermal shock can occur in regions A to C enclosed by a broken line in FIG. 2. FIG. 2 is a plan view illustrating a location of occurrence of thermal shock in the magnetic disk apparatus 1.

The regions A and B are regions in which the magnetic circuit 5b is fixed to the housing 50 with a screw, or the like. As illustrated in FIG. 3, for example, the magnetic circuit 5b includes a top yoke 5b1, a bottom yoke 5b2, a magnet 5b3, and a magnet 5b4. FIG. 3 is a sectional view taken along a line D-D in a plan view of FIG. 2, indicating a location of occurrence of thermal shock in the magnetic disk apparatus 1. The magnet 5b3 is fixed to a surface on the bottom yoke 5b2 side of the top yoke 5b1 using adhesive, or the like. The magnet 5b4 is fixed to a surface on the top yoke 5b1 side of the bottom yoke 5b2 using adhesive or the like. The magnetic circuit 5b is attached to an inner wall surface of the housing 50 with screws 61 and 62 being inserted through screw holes provided on each of the top yoke 5b1, the bottom yoke 5b2, and the housing 50.

In the regions A and B, the magnetic circuit 5b (the top yoke 5b1 and the bottom yoke 5b2), the housing 50, and the screws 61 and 62 can be formed of different materials. The top yoke 5b1 and the bottom yoke 5b2 can be formed of a substance containing a material suitable for the magnetic circuit 5b, including iron, nickel, and cobalt. The housing 50 can be formed of a substance containing metal such as aluminum. The screws 61 and 62 are formed, for example, of a substance containing metal such as steel, aluminum, titanium, and copper. Because of this variation, when the absolute value of the temperature gradient in the vicinity of the actuator 15 increases to exceed a particular value, a difference in the coefficient of thermal expansion between the magnetic circuit 5b and the housing 50, and a difference in the coefficient of thermal expansion between the magnetic circuit 5b and the screws 61 and 62 might generate, in some cases, stress in a coupling portion between the magnetic circuit 5b and the housing 50. In a case where the stress due to the difference in the coefficient of thermal expansion exceeds a fastening force of the screws 61 and 62, the stress can be instantaneously released and cause occurrence of impulse-like shock toward the magnetic circuit 5b, the housing 50, and the screws 61 and 62. This shock (thermal shock) can act on the actuator 15.

The region C is a region in which a flexible printed circuit (FPC) 40 and a retainer 30 are fixed to the arm 4 with a screw, or the like. The FPC 40 is a flexible and highly deformable printed substrate, on which wiring between the preamplifier 6 and the RWC 11 is patterned, for example. The retainer 30 is a reinforcing plate provided for reinforcing a strength of a tip portion on the arm 4 side, on the FPC 40. For example, as illustrated in FIG. 4, a package of the preamplifier 6 is mounted in a region reinforced by the retainer 30, on the FPC 40. Subsequently, by inserting a screw 63 through screw holes on each of the FPC 40, the retainer 30, and the arm 4, the FPC 40 is mounted on a side surface of the arm 4 via the retainer 30.

In the region C, the FPC 40, the retainer 30, and the screw 63 can be formed of different materials. The FPC 40 can be formed, for example, of a substance containing resin such as polyimide. The retainer 30 is formed of a substance containing metal such as aluminum. The screw 63 is formed, for example, of a substance containing metal such as steel, aluminum, titanium, and copper. Because of this variation, when the absolute value of the temperature gradient in the vicinity of the actuator 15 increases to exceed a predetermined value, a difference in the coefficient of thermal expansion between the FPC 40 and the retainer 30, and the difference in the coefficient of thermal expansion between the FPC 40 and the screw 63 might generate, in some cases, stress in a coupling portion between the FPC 40 and the retainer 30, and a coupling portion between the retainer 30 and the arm 4. When the stress due to the difference in the coefficient of thermal expansion exceeds a fastening force of the screw 63, the stress is instantaneously released, which causes occurrence of impulse-like shock toward the FPC 40, the retainer 30 and the screw 63. This shock (thermal shock) can act on the actuator 15.

In the magnetic disk apparatus 1 in recent years, there is a trend of increasing density of data stored in the magnetic disk 2. Along with this, there is a trend of narrowing a track pitch of the magnetic disk 2. At the time of writing data with a magnetic head toward a magnetic disk with a narrow track pitch, it is desirable to suppress writing in an offtrack state even when the magnetic head 3 is affected by thermal shock via the actuator 15.

An exemplary possible solution would be to impose a stricter requirement for an offtrack slice, as illustrated in FIG. 5. FIG. 5 is a diagram illustrating write operation of the magnetic disk apparatus 1. For example, in positioning control of the magnetic head 3 by the MCU 9, it is possible to provide offtrack slices ΔSP1 and ΔSP2 each of which has a width significantly narrower than a half of a track width. In data write operation onto a track Trk_n, the MCU 9 calculates the amount of deviation of the position of the magnetic head 3 from a track center CP based on servo information read from the servo region SR. When the amount of deviation is outside the range of the offtrack slices ΔSP1 and ΔSP2, it is possible to stop write operation. With this procedure, it is expected to be able to suppress offtrack of the magnetic head 3 and writing into adjacent tracks Trk_(n−1) and Trk_(n+1).

At this time, in a data region DR between a servo region SR and a subsequent servo region SR, vibration of the magnetic head 3 due to thermal shock might occur. When amplitude of the vibration of the magnetic head 3 due to thermal shock is smaller relative to the track width, the magnetic head 3 is not likely to become offtrack during write operation into the data region DR, enabling suppression of writing to an adjacent track. Meanwhile, along with a progress of increasing density (narrower track pitches) of the magnetic disk 2, the amplitude of vibration of the magnetic head 3 due to thermal shock can be greater relative to the track width. With this operation, as illustrated with broken lines in FIG. 5, the magnetic head 3 might become offtrack during write operation into the data region DR. This offtrack might cause the magnetic head 3 to write information onto the adjacent track Trk_(n−1), leading to an error such as loss of the information already written in the adjacent track Trk_(n−1). In order to suppress writing in an offtrack state by the magnetic head 3 attributed to vibration due to thermal shock, detection of thermal shock would be required.

In order to detect occurrence of thermal shock, the magnetic disk apparatus 1 further includes a shock detection circuit 20 including an acceleration sensor 21, as illustrated in FIG. 1. The shock detection circuit 20 amplifies an output signal of the acceleration sensor 21 with a gain controlled by the controller 17. The shock detection circuit 20 passes the amplified output signal through a filter (e.g., a low-pass filter 23) with a passband width controlled by the controller 17. Then, the shock detection circuit 20 detects acceleration with using the passed and amplified output signal.

For example, the shock detection circuit 20 includes the acceleration sensor 21, an amplifier circuit 22, the low-pass filter 23, and a shock determination circuit 24. Additionally, a configuration including the SPM driving circuit 8, the VCM driving circuit 10, the amplifier circuit 22, the low-pass filter 23, and the shock determination circuit 24 can be mounted as a servo controller (SVC) 18.

The acceleration sensor 21 is arranged near the actuator 15 inside or outside of the housing 50 (refer to FIG. 2), detects acceleration of the housing 50 corresponding to the shock acting on the actuator 15, and supplies an output signal corresponding to a detection result to the amplifier circuit 22. The amplifier circuit 22 amplifies the output signal of the acceleration sensor 21 at a gain controlled by the MCU 9 and supplies the amplified signal to the low-pass filter 23. The low-pass filter 23 passes frequencies of the amplified signal within a passband width controlled by the MCU 9. That is, the low-pass filter 23 removes a noise component (radio frequency component) from the amplified signal at a cut-off frequency controlled by the MCU 9, and supplies the signal from which the noise component has been removed, to the shock determination circuit 24. The shock determination circuit 24 compares the supplied signal with a threshold (predetermined value) and outputs a comparison result indicating shock has occurred in a case where the supplied signal exceeds the threshold. The shock determination circuit 24 outputs a comparison result indicating that the shock has not occurred in a case where the supplied signal is smaller than the threshold. The shock determination circuit 24 can be formed with, for example, a comparator, on which a signal is input from a non-inverted input terminal and a reference voltage as a threshold is input from an inverted input terminal. Specifically, in a case where the amplitude of vibration due to thermal shock is greater relative to the track width, write operation of the magnetic head 3 is stopped according to strict offtrack slice (ΔSP1/ΔSP2) setting and shock detection by the acceleration sensor 21. With this operation, it is possible to suppress writing in an offtrack state by the magnetic head 3 attributed to vibration due to thermal shock.

However, with further progress of increasing density (narrower track pitches) of the magnetic disk 2, enhancing thermal shock detection accuracy might become difficult.

For example, making the offtrack slice setting too strict could lead to determination of out-of-range from the offtrack slices ΔSP1 and ΔSP2 (offtrack state) even in a case where thermal shock does not occur. This leads to frequent stops of write operation. This is likely to lower performance of write operation of the magnetic disk apparatus 1.

In another case where sensitivity of the shock detection circuit 20 is set too high, a noise component in the output signal of the acceleration sensor 21 might be mis-detected as shock even when no thermal shock occurs. This also leads to frequent stops of write operation. This consequently would lower performance of write operation of the magnetic disk apparatus 1.

Accordingly, in the present embodiment, the temperature in the vicinity of the actuator 15 is measured on the magnetic disk apparatus 1 and then the shock detection circuit 20 is adjusted to a state in which thermal shock is easily detected selectively when the absolute value of the temperature gradient is great (when occurrence of thermal shock is expected). This adjustment allows to enhance thermal shock detection accuracy when occurrence of thermal shock is expected while avoiding mis-detection at a normal time (when thermal shock is not expected).

Specifically, as illustrated in FIG. 1, the magnetic disk apparatus 1 further includes a temperature measurement circuit 60. The temperature measurement circuit 60 is arranged near the actuator 15 inside the housing 50 (refer to FIG. 2) and measures a temperature in the housing 50 (e.g., in the vicinity of the actuator 15) corresponding to a temperature of the actuator 15. The temperature measurement circuit 60 is, for example, a thermistor (temperature sensor using semiconductor), a temperature measurement resistor (temperature sensor using metal such as platinum, nickel, and copper), and a linear resistor (temperature sensor using alloy of nickel or palladium).

The MCU 9 receives an output signal from the temperature measurement circuit 60. The MCU 9 changes sensitivity of the shock detection circuit 20 according to a temperature change rate (temperature gradient) obtained from the temperature measured by the temperature measurement circuit 60. In order to change sensitivity of the shock detection circuit 20, the MCU 9 can execute at least one of control of first control and second control. The first control is control of changing the gain of the shock detection circuit 20. The first control includes changing the gain of the amplifier circuit 22. The second control is control of changing the passband width of the shock detection circuit 20. The second control includes changing the passband width of the low-pass filter 23. Changing the passband width of the low-pass filter 23 includes changing the cut-off frequency of the low-pass filter 23.

As the first control, the MCU 9 controls sensitivity of the shock detection circuit 20 to first sensitivity in a case where the absolute value of the temperature change rate (temperature gradient) is a first value and is lower than a predetermined value. The MCU 9 controls sensitivity of the shock detection circuit 20 to second sensitivity in a case where the absolute value of the temperature change rate (temperature gradient) is a second value and is higher than the predetermined value. The second sensitivity is higher than the first sensitivity. The predetermined value is previously determined as a value such that when the temperature change rate (temperature gradient) exceeds the value, occurrence of thermal shock is expected. The first value is lower than the second value and is lower than the predetermined value. The second value is higher than the first value and is higher than the predetermined value.

For example, the MCU 9 increases the gain of the amplifier circuit 22 when the absolute value of the temperature gradient is greater than the predetermined gradient and controls the shock detection circuit 20 such that the thermal shock is easily detected. Accordingly, the MCU 9 controls the gain of the amplifier circuit 22 to a first gain in a case where the absolute value of the temperature change rate is the first value and is lower than the predetermined value. The MCU 9 controls the gain of the amplifier circuit 22 to a second gain in a case where the absolute value of the change rate of temperature is a second value and is higher than the predetermined value. The second gain is higher than the first gain.

As the second control, the MCU 9 controls the passband width of the shock detection circuit 20 to the first width in a case where the absolute value of the temperature change rate is the first value and is lower than a predetermined value. The MCU 9 controls the passband width of the shock detection circuit 20 to the second width in a case where the absolute value of the temperature change rate is the second value and is higher than the predetermined value. The second width is wider than the first width.

For example, the MCU 9 controls the shock detection circuit 20 so as to easily detect the thermal shock by increasing the cut-off frequency of the low-pass filter 23 when the absolute value of the temperature gradient is greater than a predetermined value. The MCU 9 controls the cut-off frequency of the low-pass filter 23 to a first cut-off frequency in a case where the absolute value of the temperature change rate is the first value and is lower than a predetermined value. The MCU 9 controls the cut-off frequency of the low-pass filter 23 to a second cut-off frequency in a case where the absolute value of the temperature change rate is the second value and is higher than the predetermined value. The second cut-off frequency is higher than the first cut-off frequency.

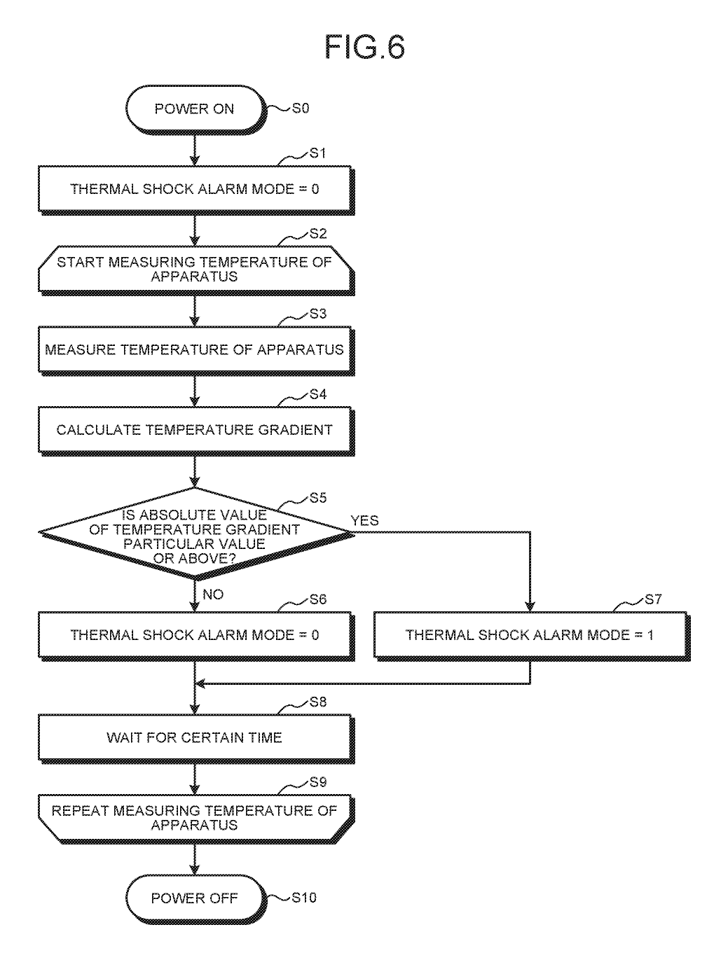

More specifically, the magnetic disk apparatus 1 performs operations illustrated in FIG. 6. FIG. 6 is a flowchart illustrating operation of the magnetic disk apparatus 1.

The MCU 9 includes a thermal shock alarm mode as a mode to manage, in relation with a state of the magnetic disk apparatus 1, an occasion in which occurrence of thermal shock is expected and an occasion in which no occurrence of thermal shock is expected. When the MCU 9 detects power-on of the magnetic disk apparatus 1 (S0), the MCU 9 sets the thermal shock alarm mode to “0” as a default value (S1), and then, starts reception of an output signal of the temperature measurement circuit 60, and starts measurement (monitoring) of the temperature of the magnetic disk apparatus 1 (S2).

The temperature measurement circuit 60 measures a temperature in the vicinity of the actuator 15 (S3) and supplies the output signal corresponding to the measured temperature to the MCU 9. The MCU 9 can identify the temperature measured by the temperature measurement circuit 60 according to the output signal of the temperature measurement circuit 60. Based on the temperature measured by the temperature measurement circuit 60 at a plurality of different times, the MCU 9 calculates temperature gradient (temperature change rate) (S4).

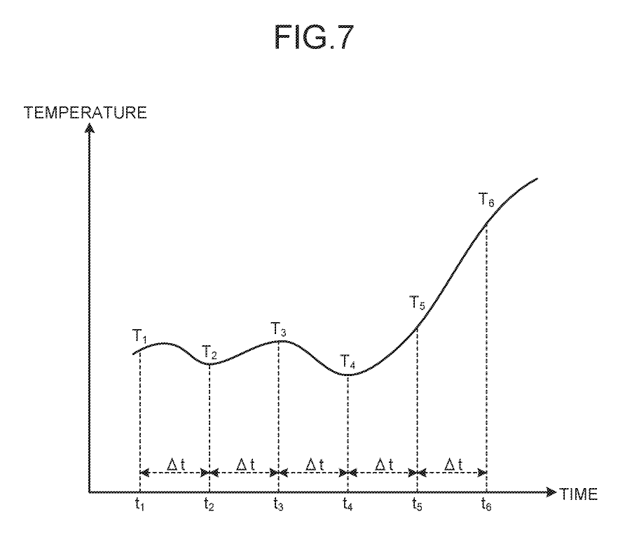

For example, as illustrated in FIG. 7, a temperature measurement period is assumed to be Δt (for example, four minutes), measured temperatures at successive times t1, t2, t3, t4, t5, and t6 with the period Δt are respectively assumed to be T1, T2, T3, T4, T5, and T6. At this time, the temperature gradient for the terms between individual times can be calculated as:

term t1 to t2: (T2−T1)/Δt=ΔT12,

term t2 to t3: (T3−T2)/Δt=ΔT23,

term t3 to t4: (T4−T3)/Δt=ΔT34,

term t4 to t5: (T5−T4)/Δt=ΔT45, and

term t5 to t6: (T6−T5)/Δt=ΔT56.

Based on the calculated temperature gradient (temperature change rate), the MCU 9 judges whether the absolute value of the temperature gradient in the vicinity of the actuator 15 is greater than a particular value (S5). Specifically, the MCU 9 compares the temperature gradient and the particular value for each term.

At this time, when the absolute value of the temperature gradient (temperature change rate) is lower than the particular value for one term (S5: No), the MCU 9 determines that occurrence of thermal shock is not expected and sets the thermal shock alarm mode to “0” (S6). At this time, when the absolute value of the temperature gradient (temperature change rate) exceeds the particular value for one term (S5: Yes), the MCU 9 determines that occurrence of thermal shock is expected (occurrence of thermal shock should be alarmed) and sets the thermal shock alarm mode to “1” (S7).

In an example illustrated in FIG. 7, when the particular value for the temperature gradient (temperature change rate) is Tth (positive value),

|ΔT12|<Tth

|ΔT23|<Tth

|ΔT34|<Tth

|ΔT45|>Tth

|ΔT56|>Tth

would be satisfied. For example, in a case where it is known that thermal shock occurs when the temperature is increased or decreased by 15° C. for an hour, it is possible to calculate as: Tth=15° C./(60 minutes)=0.25 (° C./minute). The MCU 9 can set the thermal shock alarm mode to =0 until time t5, and set the thermal shock alarm mode=1 corresponding to a fact of “|ΔT45|>Tth” immediately after time t5. Accordingly, it is possible to promptly detect that the state has shifted to the state in which occurrence of thermal shock should be alarmed and change a value of the thermal shock alarm mode.

Alternatively, when the condition that the absolute value of the temperature gradient (temperature change rate) exceeds the particular value is not satisfied successively for a plurality of terms, the MCU 9 may determine that the absolute value of the temperature gradient is (substantially) smaller than the particular value (S5: No) and that occurrence of thermal shock is not expected, and may set the thermal shock alarm mode to “0” (S6). In this example, when the condition that the absolute value of the temperature gradient (temperature change rate) exceeds the particular value is satisfied successively for the plurality of terms, the MCU 9 determines that the absolute value of the temperature gradient is (substantially) greater than the particular value (S5: Yes) and that occurrence of thermal shock is expected (occurrence of thermal shock should be alarmed), and sets the thermal shock alarm mode to “1” (S7).

In an example illustrated in FIG. 7, the MCU 9 can set the thermal shock alarm mode=0 until time t6, and set, at the time t6, the thermal shock alarm mode=1 corresponding to a fact of “|ΔT45|>Tth” and “|ΔT56|>Tth” for two successive terms (terms of t4 to t5 and terms of t5 to t6). Consequently, it is possible to reliably detect that the state has shifted to a state in which occurrence of thermal shock should be alarmed and to change a value of the thermal shock alarm mode.

Subsequently, the MCU 9 waits for a period (certain time) Δt to detect a temperature to elapse (S8), and when power-off is not required, processing returns to an initial state of a loop (S2), and again, processing of S3 to S8 is executed. In other words, a loop of S2 to S9 is repeated until power of the magnetic disk apparatus 1 is turned off (S9). When the power of the magnetic disk apparatus 1 is turned off (S10), processing is finished.

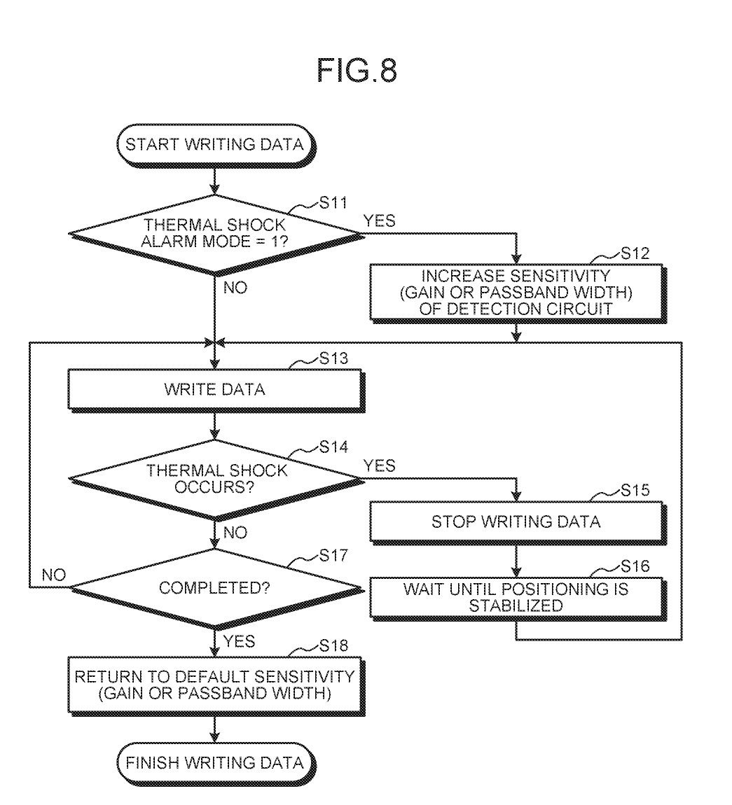

Next, write operation of the magnetic disk apparatus 1 will be described with reference to FIG. 8. FIG. 8 is a flowchart illustrating write operation of the magnetic disk apparatus 1.

The MCU 9 examines, in a timing in which write operation onto the magnetic disk 2 should be executed, whether the value of thermal shock alarm mode is “1” (S11). When the thermal shock alarm mode=1 (S11: Yes), the MCU 9 adjusts the shock detection circuit 20 to a state in which thermal shock is easily detected. Specifically, the MCU 9 increases the sensitivity of the shock detection circuit 20. For example, the MCU 9 executes at least one of control of the first control and the second control (S12). The first control is a control of increasing the gain of the shock detection circuit 20 (gain of the amplifier circuit 22) from the first gain to the second gain. The second control is a control of widening the passband width of the shock detection circuit 20 from the first width to the second width (e.g., increasing the cut-off frequency of the low-pass filter 23 in the shock detection circuit 20 from a first cut-off frequency to a second cut-off frequency). In other words, the MCU 9 may execute, at S12, any one of the first control and the second control, or both of the first control and the second control. When the thermal shock alarm mode=0 (S11: No), the MCU 9 skips S12.

While writing data onto the magnetic disk 2 (S13), the MCU 9 detects presence or absence of occurrence of thermal shock by the shock detection circuit 20 (S14). When thermal shock is detected by the shock detection circuit 20 (S14: Yes), the MCU 9 stops write operation (S15). By stopping write operation in a timing, for example, indicated with the ‘x’ mark illustrated in FIG. 5, it is possible to avoid writing onto an offtrack position indicated by the broken line. Subsequently, the MCU 9 waits until positioning control of the magnetic head 3 is stabilized, namely, until the offtrack state is cleared (S16). For example, when the magnetic head 3 reaches the servo region SR and read servo information from the servo region SR, the MCU 9 can control the position of the magnetic head 3 to return to the target track Trk_n. Then, the MCU 9 can determine that the offtrack state is cleared by detecting the position of magnetic head 3 is within the range of the offtrack slices ΔSP1 and ΔSP2 with respect to the target track Trk_n. When the positioning control is stabilized (offtrack state is cleared), the MCU 9 restarts writing data onto the magnetic disk 2. While writing data onto the magnetic disk 2 (S13), the MCU 9 detects presence or absence of occurrence of thermal shock by the shock detection circuit 20 (S14).

When thermal shock has not been detected by the shock detection circuit 20 (S14: No), until completion of data that should be written (S17: No), the MCU 9 repeats processing from S13 to S17. Upon completion of data that should be written (S17: Yes), the MCU 9 returns a state to the state before execution of control of S12 (S18), and finishes write operation.

If the sensitivity of the shock detection circuit 20 has been increased from the first sensitivity to the second sensitivity in S12, the sensitivity of the shock detection circuit 20 is returned from the second sensitivity to the first sensitivity. For example, if the gain of the shock detection circuit 20 (the gain of the amplifier circuit 22) has been increased from the first gain to the second gain in S12, the gain of the amplifier circuit 22 is returned from the second gain to the first gain. If the passband width of the shock detection circuit 20 has been widened from the first width to the second width at S12, the passband width of the shock detection circuit 20 is returned from the second width to the first width. For example, if the cut-off frequency of the low-pass filter 23 has been increased from the first cut-off frequency to the second cut-off frequency at S12, the cut-off frequency of the low-pass filter 23 is returned from the second cut-off frequency to the first cut-off frequency.

It should be noted that, in S17, determination of completion of data to be written may be performed for data in a unit of write command, data in a unit of zone provided concentrically so as to include a plurality of tracks on the magnetic disk 2, and data before seek operation of the actuator 15 for track change is started. Alternatively, when positioning control is stabilized (offtrack state is cleared) in S16, processing may be returned to the state before execution of control of S12 (S18), and thereafter, the processing may be returned to S11.

As described above, in the present embodiment, the temperature in the vicinity of the actuator 15 is measured on the magnetic disk apparatus 1, and then, the sensitivity of the shock detection circuit 20 is controlled to be higher when the absolute value of the temperature gradient is greater than a particular value (when occurrence of thermal shock is expected). For example, the MCU 9 executes at least one of control of the first control and the second control corresponding to a fact that the temperature change rate measured by the temperature measurement circuit 60 has exceeded the predetermined value. The first control is control of increasing gain of the shock detection circuit 20. The second control is control of widening the passband width of the shock detection circuit 20. With this control, it is possible, while avoiding mis-detection of thermal shock by the shock detection circuit 20 at a normal time (when occurrence of thermal shock is not expected), to enhance thermal shock detection accuracy of the shock detection circuit 20 when occurrence of thermal shock is expected.

It should be noted that operation when the output signal of the acceleration sensor 21 is at a first level that is a level in the vicinity of a threshold, specifically, being slightly lower than the threshold, will be discussed. At this time, in a case where the change rate of an output signal of the temperature measurement circuit 60 is the first value and is lower than a predetermined level and the setting is such that the thermal shock alarm mode=0 (first case), the MCU 9 skips operation of S12 in FIG. 8. Accordingly, for the output signal at the first level, detection at the shock detection circuit 20 indicates no thermal shock. In response to this, the MCU 9 continues write operation of the magnetic head 3 onto the magnetic disk 2. Meanwhile, in a case where the change rate of the output signal of the temperature measurement circuit 60 is the second value and is higher than a predetermined level and the setting is such that the thermal shock alarm mode=1 (second case), the MCU 9 executes control of S12 in FIG. 8 and adjusts the shock detection circuit 20 to a state in which thermal shock is easily detected. Accordingly, for the output signal at the first level, detection at the shock detection circuit 20 indicates occurrence of thermal shock. Accordingly, the MCU 9 stops write operation of the magnetic head 3 onto the magnetic disk 2. In short, operation of the MCU 9 in response to the output signal at the first level from the acceleration sensor 21 can differ depending on whether the control of S12 in FIG. 8 has been executed or not.

Compared with the case (first case) where setting of the thermal shock alarm mode=0 and control of S12 in FIG. 8 is not executed, it is more likely that write operation would be stopped in a case (second case) where setting of the thermal shock alarm mode=1 and control of S12 in FIG. 8 is executed. In other words, in view of a predetermined unit of time, frequency of stops of write operation in a case where control of S12 in FIG. 8 is executed is more than the frequency of stops of write operation in a case where the control of S12 in FIG. 8 is not executed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk apparatus comprising:
an actuator that holds a magnetic head that accesses a magnetic disk;
a shock detection circuit including an acceleration sensor that detects acceleration during driving of the actuator;
a temperature measurement circuit that measures a temperature during driving of the actuator; and
a controller circuit that changes sensitivity of the shock detection circuit according to a temperature change rate obtained from the measured temperature.

2. The magnetic disk apparatus according to claim 1,
wherein the controller circuit changes the sensitivity according to the temperature change rate while executing write operation with the magnetic head onto the magnetic disk, and stops the write operation in a case where an output signal of the acceleration sensor exceeds a particular value.

3. The magnetic disk apparatus according to claim 1,
wherein the controller circuit changes the sensitivity according to the temperature change rate while executing write operation with the magnetic head onto the magnetic disk, and at subsequent write operation after completion or stop of the write operation, returns a state to a state before changing the sensitivity.

4. The magnetic disk apparatus according to claim 1,
wherein the controller circuit changes a gain of the shock detection circuit to change the sensitivity according to the obtained temperature change rate, and
the shock detection circuit amplifies an output signal of the acceleration sensor with the gain controlled by the controller circuit.

5. The magnetic disk apparatus according to claim 1,
wherein the controller circuit changes a passband width of the shock detection circuit to change the sensitivity according to the obtained temperature change rate, and
the shock detection circuit passes an output signal of the acceleration sensor through a filter with the passband width controlled by the controller circuit and detects acceleration with using the passed output signal.

6. The magnetic disk apparatus according to claim 1,
wherein the controller circuit controls the sensitivity to a first sensitivity in a case where an absolute value of the temperature change rate is a first value, and controls the sensitivity to a second sensitivity higher than the first sensitivity in a case where the absolute value of the temperature change rate is a second value higher than the first value.

7. The magnetic disk apparatus according to claim 4,
wherein the controller circuit controls the gain of the shock detection circuit to a first gain in a case where an absolute value of the temperature change rate is a first value, and controls the gain of the shock detection circuit to a second gain higher than the first gain in a case where the absolute value of the temperature change rate is a second value higher than the first value.

8. The magnetic disk apparatus according to claim 5,
wherein the controller circuit controls the passband width of the shock detection circuit to a first width in a case where an absolute value of the temperature change rate is a first value, and controls the passband width of the shock detection circuit to a second width wider than the first width in a case where the absolute value of the temperature change rate is a second value higher than the first value.

9. The magnetic disk apparatus according to claim 1,
wherein the controller circuit controls the sensitivity to a first sensitivity in a case where an absolute value of the temperature change rate is a first value at least one in a first term and in a second term subsequent to the first term, and controls the sensitivity to a second sensitivity higher than the first sensitivity in a case where the absolute value of the temperature change rate is a second value higher than the first value both in the first term and in the second term.

10. The magnetic disk apparatus according to claim 4,
wherein the controller circuit controls the gain of the shock detection circuit to a first gain in a case where an absolute value of the temperature change rate is a first value at least one in a first term and in a second term subsequent to the first term, and controls the gain of the shock detection circuit to a second gain higher than the first gain in a case where the absolute value of the temperature change rate is a second value higher than the first value both in the first term and in the second term.

11. The magnetic disk apparatus according to claim 5,
wherein the controller circuit controls the passband width of the shock detection circuit to a first width in a case where an absolute value of the temperature change rate is a first value at least one in a first term and in a second term subsequent to the first term, and controls the passband width of the shock detection circuit to a second width wider than the first width in a case where the absolute value of the temperature change rate is a second value higher than the first value both in the first term and in the second term.

12. The magnetic disk apparatus according to claim 1,
wherein the shock detection circuit further includes an amplifier circuit that amplifies an output signal of the acceleration sensor at a gain controlled by the controller circuit, and
the controller circuit controls the gain of the amplifier circuit to a first gain in a case where an absolute value of the temperature change rate is a first value and controls the gain of the amplifier circuit to a second gain higher than the first gain in a case where the absolute value of the temperature change rate is a second value higher than the first value.

13. The magnetic disk apparatus according to claim 1,
wherein the shock detection circuit further includes a low-pass filter that removes a noise component from an output signal of the acceleration sensor at a cut-off frequency controlled by the controller circuit, and
the controller circuit controls a cut-off frequency of the low-pass filter to a first cut-off frequency in a case where an absolute value of the change rate is a first value, and controls the cut-off frequency of the low-pass filter to a second cut-off frequency higher than the first cut-off frequency in a case where the absolute value of the change rate is a second value higher than the first value.

14. The magnetic disk apparatus according to claim 1,
wherein the acceleration sensor detects the acceleration of a housing corresponding to a shock acting on the actuator, and
the temperature measurement circuit measures a temperature in the housing corresponding to a temperature of the actuator.

15. A magnetic disk apparatus comprising:
an actuator that holds a magnetic head that accesses a magnetic disk;
an acceleration sensor that detects acceleration during driving of the actuator; and
a temperature measurement circuit that measures a temperature during driving of the actuator;
wherein the magnetic disk apparatus continues write operation with the magnetic head onto the magnetic disk in a first case where an output signal of the acceleration sensor is at a first level and an absolute value of a change rate of an output signal of the temperature measurement circuit is a first value, and stops the write operation in a second case where the output signal of the acceleration sensor is at the first level and the absolute value of the change rate of the output signal of the temperature measurement circuit is a second value higher than the first value.

16. The magnetic disk apparatus according to claim 15,
wherein, in the first case, frequency of stops of the write operation in a particular term is a first frequency, and in the second case, frequency of stops of the write operation in the particular term is a second frequency higher than the first frequency.

17. The magnetic disk apparatus according to claim 15,
wherein the acceleration sensor detects the acceleration of a housing corresponding to a shock acting on the actuator, and
the temperature measurement circuit measures a temperature in the housing corresponding to a temperature of the actuator.

18. A control method of a magnetic disk apparatus including an actuator and a shock detection circuit, the actuator holding a magnetic head that accesses a magnetic disk, the shock detection circuit including an acceleration sensor that detects acceleration during driving of the actuator, the method comprising:
measuring a temperature during driving of the actuator; and
changing sensitivity of the shock detection circuit according to a temperature change rate obtained from the measured temperature.

19. The control method according to claim 18,
wherein the changing includes changing the sensitivity according to the temperature change rate while executing write operation of the magnetic head onto the magnetic disk, and
the control method further includes stopping the write operation in a case where an output signal of the acceleration sensor exceeds a predetermined value.

20. The control method according to claim 18,
wherein the changing includes changing the sensitivity according to the temperature change rate while executing write operation of the magnetic head onto the magnetic disk, and
the control method further includes returning, at subsequent write operation after completion or stop of the write operation, a state to a state before changing the sensitivity.
